(19) United States
(12) Patent Application Publication
(10) Pub. No.: US 2014/0243518 A1
(43) Pub. Date: Aug. 28, 2014

(54) Method for Preparing Cationic Galactomannans

(71) Applicant: RHODIA OPERATIONS, Aubervilliers (FR)

(72) Inventors: Jean-Claude Le-Thiesse, Saint Etienne (FR); Sebastien Lomel, Saint Just Chaleyssin (FR); Thierry Gisbert, Mions (FR)

(21) Appl. No.: 14/348,907

(22) PCT Filed: Oct. 3, 2012
(86) PCT No.: PCT/EP2012/069549

§ 371 Date: Apr. 1, 2014

(30) Foreign Application Priority Data
Oct. 3, 2011 (FR) 1158914

(51) Int. Cl. C08B 37/00

(52) U.S. Cl. CPC C08B 37/0096
USPC 536/123

(57) ABSTRACT

The present invention relates to a method for preparing cationic galactomannans, comprising the following steps:
a) a step in which galactomannans are impregnated with an alkaline agent;
b) a step in which the mixture formed in step a) is impregnated with a cationic agent; and
c) a step in which the mixture is formed in step b) is dried.

### CROSS-REFERENCE TO RELATED APPLICATIONS

This application is a U.S. national stage entry under 35 U.S.C. §371 of International Application No. PCT/EP2012/069549 filed Oct. 3, 2012, which claims priority to French Application No. 1158914 filed on Oct. 3, 2011, the whole content of these applications being herein incorporated by reference for all purposes.

### TECHNICAL FIELD

The present invention relates to a novel process for preparing cationic galactomannans and especially cationic guars.

### BACKGROUND ART

Galactomannans are polysaccharides composed mainly of galactose and mannose units, in which the mannose units are linked via a 1-4-β glucoside bond and the galactose units are linked to the mannose units via a 1-6-α bond. Each ring of the galactose or mannose units (sugar units) bears three free hydroxyl groups that are available for a chemical reaction.

Galactomannan is a soluble, calorie-free plant fiber present in seeds, which serves as a sugar reserve during germination. It is abundant in the albumin of seeds of leguminous plants, such as Cyamopsis tetragonoloba (guar gum), Caesalpinia spinosa (tara gum) and Ceratonia siliqua (locust bean gum).

Modified natural galactomannans are essentially used in the form of powders (meals) in various fields, for example in the petroleum, textile, food, pharmaceutical and cosmetics fields, in the paper industry, or alternatively in explosives or in water treatment. Natural galactomannans have especially been used for several years in papermaking to improve the strength of paper.

In order to improve the properties of galactomannans, it is especially possible to modify galactomannans to make them cationic.

Thus, U.S. Pat. No. 4,940,784 describes a process for the dry cationization of galactomannans, comprising reaction with alkylene epoxides in the presence of water in an alkaline medium and of fine hydrophobic silica. This process makes it possible to dispense with the drying steps. However, the use of silica then generates a product whose dispersions in water are cloudy. Finally, this prior art process only manages to achieve low selectivities, i.e. less than 50%, as measured for the final product after storage and as defined below.

### SUMMARY OF THE INVENTION

The aim of the present invention is to provide an improved process for preparing cationic galactomannans, which affords one or more of the following improvements:
high selectivity, especially a selectivity of greater than or equal to 50%, especially greater than or equal to 60%, for example greater than or equal to 70%, for example greater than or equal to 80%; and/or
a satisfactory moisture content, especially a moisture content of less than or equal to 10%, for example less than or equal to 7%, for example less than or equal to 5% after the drying step; and/or
resulting in the production of a final product in the form of a powder whose aqueous dispersion is clear; and/or
it is more economical and/or more ecological to use, especially on an industrial scale,
   while at the same time leading to cationic galactomannans which have properties comparable to those obtained from the prior art processes, especially in terms of modification of the viscosity and/or deposition of silicones.

The present invention thus relates to a process for preparing cationic galactomannan, comprising the following steps:

a) a step of impregnating galactomannan with an alkaline agent;

b) a step of impregnating the mixture formed after step a) with a cationic agent; and

c) a step of drying the mixture formed after step b).

Steps a) and b) are performed under conditions suitable for obtaining good impregnation conditions.

In the context of the present invention, the impregnation conditions are such that the impregnation is homogeneous, i.e. each galactomannan particle receives substantially the same amount of alkaline agent (step a) and of cationic agent (step b).

These impregnation steps are performed for a time sufficient for the alkaline agent and the cationic agent to become distributed as homogeneously as possible in the galactomannan.

The process according to the invention may be performed either continuously or batchwise.

According to one embodiment, the process of the invention is performed continuously.

In the context of the process of the invention, the galactomannan may be in the form of a powder or in the form of splits.

The term “galactomannan splits” denotes a particular form of galactomannans. This form corresponds to the endosperm of the plant from which the galactomannan is derived. It consists of solid galactomannan objects from 3 to 4 mm in size.

In the context of the present invention, the impregnation is all the more effective when the galactomannan particles are in the form of splits. In this case, the alkaline and cationic agents are absorbed more slowly than in the case of powders and are therefore even better distributed between the particles. The distribution of the alkaline and cationic agents is thus improved and even more homogeneous.

This particular embodiment, namely the use of galactomannans in the form of splits, thus enables particularly effective and homogeneous impregnation.

According to one embodiment, the cationic galactomannans obtained after the process of the invention have a degree of cationic substitution DS_{cat} ranging from 0.1 to 0.3.

For the purposes of the present invention, the term “degree of cationic substitution DS_{cat}” means the mean number of moles of cationic groups per mole of galactomannan units. This degree of cationic substitution can be measured by ¹H NMR (solvent: D₂O or DMSO).

According to one embodiment, the process of the invention advantageously makes it possible to achieve selectivities, measured after the drying step c), of greater than or equal to 50%, especially greater than or equal to 60%, for example greater than or equal to 70%, or even greater than or equal to 80%.

For the purposes of the present invention, the term “selectivity” of the cationization process means the ratio between the number of cationic groups grafted onto the final product and the number of cationic groups introduced into the reaction medium.

The selectivity may be determined by establishing the ratio between the real DS_{cat} measured by ¹H NMR (solvent: D₂O or DMSO) at the end of the process (on a prewashed sample) and the calculated maximum theoretical DS_{cat} as a function of the total molar amounts of reagents introduced into the reaction medium.

Unless otherwise indicated, the pressure applied is atmospheric pressure (1 bar).

The term “alkaline agent” denotes a basic agent chosen especially from the group consisting of alkali metal silicates, alkali metal aluminates, alkali metal hydroxides, alkali metal oxides, alkali metal carbonates, alkaline-earth metal hydroxides and alkaline-earth metal oxides, and mixtures thereof.

According to a particular embodiment, the alkaline agent used for step a) is an aqueous solution of sodium hydroxide or potassium hydroxide, and preferentially of sodium hydroxide.

After step a), galactomannan is obtained, especially in the form of splits, impregnated with alkaline agent.

Step b) consists in adding a cationic agent to the galactomannan impregnated with alkaline agent.

The aim of this step is to graft cationic groups onto the galactomannans. After this step, cationic galactomannans are obtained, also referred to hereinbelow as grafted galactomannans.

The term “cationic agent” denotes a compound bearing at least one cationic group. In the text hereinbelow, the term “cationic groups” denotes positively charged groups and also partially positively charged groups.

The term “partially positively charged groups” denotes groups that can become positively charged as a function of the pH of the medium in which they are present. These groups may also be referred to as “potentially cationic groups”.

In the text hereinabove and hereinbelow, the term “cationic” also means “at least partially cationic”.

The cationic agent is also referred to as a “grafting agent” or “cationization agent”. The cationic group(s) borne by this agent bonds to the galactomannan, via the free hydroxyl groups, to form after the process of the invention a cationic galactomannan, i.e. a galactomannan bearing at least one cationic group.

The reaction may thus be represented according to the following simplified scheme:

galactomannan+cationic agent→impregnated cationic galactomannan

G A-X⁺→G-X⁺

Thus, in the context of the present invention, the terms “cationic agent” and “cationic group” include ammonium compounds (with a positive charge), but also primary, secondary and tertiary amine compounds and also precursors thereof.

The cationic agents according to the present invention may be defined as compounds which, by reaction with the hydroxyl groups of the galactomannan, may lead to the formation of a modified galactomannan (cationic galactomannan).

According to the present invention, examples of cationic agents that may be mentioned include the following compounds:
cationic epoxides, such as 2,3-epoxypropyltrimethylammonium chloride or 2,3-epoxypropyltrimethylammonium bromide;
cationic nitrogenous compounds, such as 3-halo-2-hydroxypropyltrimethylammonium chloride, for example 3-chloro-2-hydroxypropyltrimethylammonium chloride;
cationic ethylenically unsaturated monomers or precursors thereof, such as the chloride salt of trimethylammoniumpropylmethacrylamide, the methyl sulfate salt of trimethylammoniumpropylmethacrylamide, diallyldimethylammonium chloride, vinylbenzyltrimethylammonium chloride, dimethylaminopropylmethacrylamide (tertiary amine) or precursors thereof, such as N-vinylformamide or N-vinylacetamide (in which the units may be hydrolyzed after polymerization or grafting of vinylamine units).

After step b), the cationic galactomannans are subjected to a drying step.

According to a preferred embodiment, the galactomannan is chosen from guars (guar gums) or derivatives thereof. The present invention thus preferably relates to a process for the continuous preparation of cationic guar, the guar preferably being in the form of splits.

According to one embodiment, especially when the galactomannans are in the form of splits or of agglomerated powders, the process of the invention comprises, after step c), a step of milling of the dried mixture obtained after step c).

This milling step may especially make it possible to convert the galactomannan splits, especially the guar splits, into a powder.

The powder thus obtained gives, once dispersed in water, a perfectly clear dispersion, unlike, for example, the powders obtained via the prior art processes described in U.S. Pat. No. 4,940,784, which give cloudy dispersions. This may be advantageous when transparency properties are desired in the final product intended to contain the cationic galactomannan.

The various steps of the process of the invention will now been described in greater detail.

### DETAILED DESCRIPTION OF THE INVENTION

Step a)—Impregnation with the Alkaline Agent

The first step of the process consists in introducing the galactomannans, especially the galactomannan splits, into a container.

According to one embodiment, the galactomannans, especially the galactomannan splits, are placed in a container for controlling the temperature at which they are maintained, for instance an intensive mixer equipped with a jacket in which circulates a heat-exchange fluid.

The term “intensive mixer” means, for example, a ploughshare mixer or a single-axle or twin-axle paddle mixer, these tools possibly being in continuous or batch mode. It is also possible to use mixers equipped with paddles for scraping the tank bottom, such as a turbosphere (this type of tool is a batch-mode tool). Spring mixers, which are exclusively continuous-mode tools, are also suitable for use. Needless to say, these examples are not limiting.

The galactomannans, preferably the galactomannan splits, are brought to a temperature T1 below 90° C., especially below 80° C., preferably below 70° C. and preferentially below 65° C., for example between 10° C. and 65° C.

According to one embodiment, T1 is from 55° C. to 65° C. and preferably equal to about 60° C.

The galactomannan splits are placed in motion by means of a stirrer. The stirring speed in the mixer is set so as to have very frequent renewal of the galactomannans in contact with the walls of the mixer, at least once per second, for the purpose of ensuring good heat transfer to the walls and of having in the subsequent steps a homogeneous distribution of the liquid reagents throughout the mass of galactomannans. The stirring speed of the stirrer which enables this good renewal of the wall depends on the mixer technology and size.

An aqueous solution of the alkaline agent is then added in the same container to the galactomannans maintained at a temperature T1 as defined above. An aqueous sodium hydroxide solution is preferably used.

Thus, according to a particular embodiment, an aqueous sodium hydroxide solution is introduced onto the mass of galactomannans, especially in the form of splits, in motion. This introduction step may be performed by pouring or by spraying.

According to one embodiment of the process according to the present invention, the aqueous solution of the alkaline agent is added at a temperature T2 below 90° C., especially below 80° C., preferably below 70° C. and preferentially below 65° C., for example between 10° C. and 65° C.

According to one embodiment, T2 is from 55° C. to 65° C. and preferably equal to about 60° C.

Thus, before the addition step, the aqueous solution of alkaline agent is preheated to a temperature T2 as defined above.

According to one embodiment, the process of the invention comprises a step of preheating a sodium hydroxide solution to about 60° C. before introduction onto the galactomannans, the rate of introduction not being critical.

According to one embodiment of the process of the present invention, the step of addition of the alkaline agent is followed by a step of impregnation of the galactomannans with the aqueous solution of the alkaline agent, which consists in establishing conditions such that the impregnation of the galactomannans with the alkaline agent is satisfactory and homogeneous.

The impregnation time t1 must be long enough to enable the alkaline agent to diffuse homogeneously into the galactomannan particle, especially the galactomannan splits, before proceeding to the next step.

The impregnation time t1 is at least 1 minute, for example at least 5 minutes, given that there is no maximum time for the impregnation. As an illustration, the impregnation time may be, for example, between 1 minute and 120 minutes and especially between 5 minutes and 60 minutes.

According to one embodiment, especially when the drying step is performed very rapidly, for example in the form of “flash” drying as defined below, the impregnation time t1 may be at least equal to 15 minutes, for example between 15 minutes and 30 minutes, for example at least equal to 20 minutes, for example between 20 minutes and 30 minutes.

According to another embodiment, especially when the drying step is performed under conditions allowing the grafting reaction to take place (reactive drying conditions as defined below), the impregnation time t1 may be at least equal to 5 minutes, for example between 5 minutes and 15 minutes, for example between 5 minutes and 10 minutes.

This time t1 depends on T4, the temperature of the wet galactomannans, namely of the galactomannans placed in contact with the alkaline agent, especially in the form of splits. This temperature T4 itself depends on T1, the initial temperature of the dry galactomannans, namely the starting galactomannans before any introduction of impregnation agent, on T2, the temperature of the solution of alkaline agent at the time of the introduction, and on T3, the temperature of the heat-exchange fluid circulating in the mixer jacket.

Typically, when T4 is about 25° C., t1 will then be at least 30 minutes, and when T4 is about 65° C., t1 is then at least 5 minutes, given that there is no maximum limit for t1.

According to one embodiment, when the process is performed continuously, it is sought to have the optimum conditions (T1, T2, T3, t1) from the technico-economic viewpoint.

Preferably, the process is performed under conditions such that the temperature T4 of the wet galactomannans, especially in the form of splits, is maintained between 55° C. and 65° C., for example at about 60° C. in the container. Preferentially, this temperature should not exceed 65° C.

Preferably, the stirring is maintained throughout the time t1 of the impregnation step so as to ensure renewal of the galactomannan particles in contact with the wall of the mixer and thus a homogeneous temperature in the mass of particles.

According to one embodiment, step a) is performed for an impregnation time t1 of at least 15 minutes, for example between 15 minutes and 40 minutes, for example of at least 20 minutes, for example between 20 minutes and 30 minutes, at a temperature T4 of between 55° C. and 65° C.

Step b)—Impregnation with the Cationic Agent

The process according to the present invention comprises, after the step of the addition of the alkaline agent and the impregnation step, a step of addition of an aqueous solution of the cationic agent.

The cationic agent is introduced onto the mass of galactomannans impregnated with alkaline agent kept in motion in the container (preferably an intensive mixer) as defined above. This introduction step may be performed by pouring or by spraying.

The cationic agent may be chosen especially from alkylene epoxides, and more particularly from the following compounds:

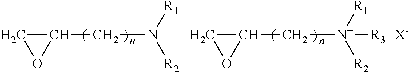

n representing an integer from 1 to 3,

R₁, R₂ and R₃ representing, independently of each other, an alkyl group comprising from 1 to 4 carbon atoms, or R₁ possibly representing a benzyl group,

X⁻ representing Cl⁻, Br⁻ or AcO⁻.

Cationic agents that may especially be mentioned include the following compounds:

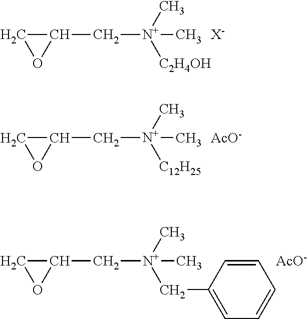

X⁻ being as defined above.

Use may also be made of the cationic agents having the following general formula:

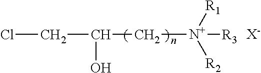

n, R₁, R₂, R₃ and X⁻ being as defined above.

Preferably, the cationic agent is 3-chloro-2-hydroxypropyltrimethylammonium chloride (Quab® 188).

Mention may also be made of 2,3-epoxypropyltrimethylammonium chloride (Quab® 151).

According to one embodiment of the process of the invention, an aqueous solution of Quab® 188 is introduced onto the mass of galactomannans, especially in the form of splits, in motion, for example by pouring.

According to one embodiment, the mass concentration of the solution of cationic agent is from 5% to 95% and preferably equal to 65% of cationic agent. Use may be made, for example, of an aqueous solution comprising 65% by weight of Quab® 188, as sold by the company Fluka.

Before being introduced onto the mass of galactomannans in motion, said solution of cationic agent is preheated to a temperature T5 below 90° C., especially below 80° C., preferably below 70° C. and preferentially below 65° C., for example between 10° C. and 65° C.

According to one embodiment, T5 is from 55° C. to 65° C.

Preferably, the solution of cationic agent, preferably of Quab® 188, is preheated to about 60° C. before introduction onto the galactomannans, the rate of introduction not being critical.

According to one embodiment of the process of the present invention, the step of addition of the cationic agent is followed by a step of impregnation of the galactomannans obtained from step a) with the aqueous solution of the cationic agent.

The impregnation time t2 must be long enough to enable the cationic agent to diffuse into the galactomannan particles, especially the galactomannan splits, before proceeding to the drying step.

The impregnation time t2 is at least 1 minute, for example at least 5 minutes, given that there is no maximum time for the impregnation. As an illustration, the impregnation time may be, for example, between 1 minute and 120 minutes and especially between 5 minutes and 60 minutes.

According to one embodiment, especially when the drying step is performed very rapidly, for example in the form of “flash” drying as defined below, the impregnation time t2 may be at least equal to 15 minutes, for example between 15 minutes and 30 minutes, for example at least equal to 20 minutes, for example between 20 minutes and 30 minutes.

According to another embodiment, especially when the drying step is performed under conditions allowing the grafting reaction to take place (reactive drying conditions as defined below), the impregnation time t2 may be at least equal to 5 minutes, for example between 5 minutes and 30 minutes, for example between 5 minutes and 15 minutes.

As previously for the alkaline agent, this time t2 depends on T6, the temperature of the wet galactomannans, namely of the galactomannans placed in contact with the cationic agent, especially in the form of splits. This temperature T6 itself depends on T4, the temperature of the galactomannans after the step of impregnation with the alkaline agent, on T5, the temperature of the solution of cationic agent at the time of the introduction, and on T3, the temperature of the heat-exchange fluid circulating in the mixer jacket.

Typically, when T6 is about 25° C., t2 will then be at least 30 minutes, and when T6 is about 65° C., t2 is then at least 5 minutes, given that there is no maximum limit for t2.

According to one embodiment, step b) is performed for an impregnation time t2 of at least 15 minutes, for example between 15 minutes and 40 minutes, for example of at least 20 minutes, for example between 20 minutes and 30 minutes, at a temperature T6 of between 55° C. and 65° C.

According to one embodiment of the process of the invention, the alkaline agent is used in excess relative to the cationic agent.

According to one embodiment of the process, the ratio between the number of moles of the alkaline agent and the number of moles of the cationic agent is from 1.5 to 2.5 and is preferably equal to 1.7.

For example, with a ratio equal to 2.1, a selectivity of 85% after drying is achieved, whereas, when this ratio is less than 1.5, for example equal to 1.3, the selectivity is reduced to 70%.

Thus, according to a preferred embodiment, the process of the invention is performed with a sodium hydroxide/Quab® 188 mole ratio equal to 1.7.

In the context of the process of the present invention, the amount of the various reagents varies according to the targeted DS value (chosen according to the intended applications). It is therefore within the competence of a person skilled in the art to choose the amounts to be used taking into account the targeted DS values and the selectivities obtained.

According to the process of the present invention, the order of the reagents is important. Preferably, all of the alkaline agent must be added before the cationic agent.

The reason for this is that it has been found that if the cationic agent is introduced first, i.e. before the alkaline agent, it diffuses more slowly to the core of the galactomannan particles, and in particular galactomannan splits. After adding the sodium hydroxide, the galactomannans remain tacky and difficult to dry. Furthermore, the selectivity is mediocre (about 48%).

Preferably, in the context of the process of the invention, the temperature of the wet galactomannans during the impregnation must not exceed 65° C.

In the presence of water, alkaline agent and cationic agent, the degradation reactions of the cationic agent, especially of Quab, accelerate greatly from 65° C. to form byproducts, the reaction selectivity being thereby degraded.

Step c)—Drying

After steps a) and b), the reaction medium comprising the wet cationized galactomannans is dried. For example, said mixture may be dried in situ in the mixer or transferred to a dryer.

According to the invention, this drying step may be performed very rapidly or under controlled conditions enabling the grafting to take place. The drying time is thus from 1 second to 180 minutes.

The drying temperature may range from 60° C. to 350° C., as a function of the drying method and of the drying time.

When the drying is performed very rapidly, i.e. over about a second, the drying temperature is high, especially about 300° C., or even up to 350° C. In this case, the drying step is a step of “flash” drying.

According to one embodiment, when the drying is of the “flash” drying type, the drying and milling steps may be simultaneous. This is then referred to as flash drying-milling.

According to another embodiment, the drying step is performed under controlled conditions, for example by circulation of air, under conditions such that the grafting reaction can take place. This is then referred to as reactive drying.

In the course of this drying step, the grafting reaction takes place, which makes it possible to obtain cationic galactomannans with a satisfactory degree of grafting and even higher selectivity.

In the context of this embodiment, the temperature T7 of the drying air may be greater than or equal to 60° C., especially between 60° C. and 150° C. and preferably between 60° C. and 100° C.

According to a preferred embodiment, the temperature of the drying air is set at about 80° C.

The drying time is adapted so that the final humidity of the grafted galactomannans, especially of the splits, is less than 5%.

Thus, according to one embodiment, the drying time t4 of step c) of reactive drying of the process of the invention is greater than or equal to 5 minutes, for example greater than or equal to 10 minutes.

According to a preferred embodiment, this drying time is from 10 minutes to 180 minutes and is preferably greater than or equal to about 15 minutes.

Thus, drying according to this embodiment leaves time for the grafting reaction to take place up to completion: the gain in selectivity during drying is thus higher.

It is preferable to control the temperature of the products obtained (galactomannans) at the end of drying, this being done at a temperature from 60° C. to 80° C. To do this, it is thus advantageous to perform the drying at controlled temperatures below 150° C.

If the temperature of the galactomannans is below 60° C., the grafting potential during drying is not fully exploited and the final selectivity is lowered (to about 70%).

If the temperature of the galactomannans exceeds 80° C., at the end of drying, a start of degradation may be observed, which is reflected by browning of the product.

According to one embodiment, the cationic galactomannans obtained after the drying step of the process of the invention have a moisture content of less than 5%.

Above this value of 5% moisture, the galactomannans obtained remain plastic and difficult to mill.

This moisture content is measured by weight loss at 80° C. using a halogen thermobalance.

Thus, by adopting a drying air temperature equal to 80° C. so as to ensure that the dry galactomannans do not exceed this temperature, the reactive drying time to achieve less than 5% residual humidity is about 15 minutes.

The choice of the drying technique is broad and will depend on the operating conditions adopted for the implementation. A stirred convective dryer is preferably used on account of the great drying uniformity obtained. For example, an optionally vibrated fluidized bed or a rotating drum is used. Although the technological choice is not critical for the quality of the final product (entirely satisfactory drying may be obtained in 3 hours in an oven at 60° C.), a particularly preferred embodiment consists in performing drying in an agitated fluidized bed.

Step d)—Milling

According to one embodiment of the process of the invention, especially when the galactomannans are in the form of splits, they must be converted into powder form. In this case, step c) is followed by a milling step d) so as to obtain a cationic galactomannan powder comprising particles of desired size.

The process of the invention has several advantages that contribute to the reduction of the cost price of the finished product and/or to better environmental performance qualities.

Firstly, the specific choice of certain particular impregnation conditions makes it possible to significantly improve the selectivity of the grafting (or cationization) reaction.

In addition, according to a preferred embodiment, the grafting (or cationization) reaction takes place during drying, which makes it possible to achieve an even higher final selectivity, especially greater than 50%, or even greater than 80%. Thus, this process makes it possible, for a targeted degree of grafting, to reduce the amount of cationic agent employed in the process.

Performing the grafting reaction in a controlled manner during drying makes it possible to achieve selectivities of 80%, or even higher. Now, leaving the product to develop on storage without a drying step, in accordance with the prior art processes, leads to lower levels of selectivity and to high contents of impurities.

The process according to the invention also has the advantage of not requiring a washing step, which eliminates the investment in equipment necessary for this operation, reduces the process times and eliminates the vast majority of the aqueous effluents. Moreover, the absence of a washing step leads to a product containing less moisture, resulting in an energy saving on drying.

Moreover, the residence time in the mixer is considerably reduced, which limits the size of the equipment required for a given productivity and makes it possible, if so desired, to develop a continuous process for the steps of impregnation with the alkaline agent and then with the cationic agent.

According to one embodiment, the process of the invention does not include the use of silica in steps a), b) and c).

Moreover, the process of the invention does not comprise a washing step.

According to one embodiment, the process of the invention may include additional steps, and in particular a step of depolymerization and/or crosslinking of the galactomannans.

For example, the process of the invention may include a step of depolymerization of the galactomannans. This step is performed before step b).

This depolymerization step is performed by using a galactomannan depolymerizing agent. Typically, as depolymerizing agent, use may be made especially of oxidizing agents, especially such as hydrogen peroxide or nitric acid, and mixtures thereof, or acids, especially such as lactic acid, tartaric acid, citric acid, phosphoric acid or sulfuric acid, and mixtures thereof.

For example, the depolymerizing agent may be introduced onto the galactomannans, especially onto the splits, before, after or even at the same time as the alkaline agent.

The process of the invention may also include a step of crosslinking of the galactomannans. This step is performed before and/or after steps a) and b).

This crosslinking step may be performed by using a galactomannan crosslinking agent.

As crosslinking agent, use may be made, for example, of a compound chosen from formaldehyde, glyoxal, halohydrins such as epichlorohydrin or epibromohydrin, phosphorus oxychloride, polyphosphates, diisocyanates, bisethylene urea, polyacids such as adipic acid or citric acid, acrolein, and the like. Chemical crosslinking may also be obtained via the action of a metal complexing agent, for instance zirconium(IV).

Chemical crosslinking may also be obtained under the effect of ionizing radiation.

The examples below are given as illustrations, but are in no way limiting.

### EXAMPLES

### Example 1

200 g of splits (Hindustan Gum & Chemicals), stored at 60° C., are placed in a laboratory mixer (Pro-C-epT, Mi-Pro 1900) equipped with a 2 liter tank. Stirring is performed with a three-blade paddle at the bottom of the tank and the stirring speed is set at 100 rpm.

The tank of this mixer is equipped with a jacket in which circulates water at 65° C.

An aqueous sodium hydroxide solution was prepared beforehand by dissolving 18.6 g of sodium hydroxide pellets (Normapur, VWR) in 100 g of water. This solution, preheated to 60° C., is poured over 30 seconds onto the splits in motion.

After 5 minutes of mixing with the sodium hydroxide solution, 80.7 g of an aqueous solution containing 65% by weight of Quab® 188 (Fluka) are poured in over 30 seconds onto the splits in motion. This Quab® solution was also preheated to 60° C. before introduction into the mixer.

After 5 minutes of mixing with the Quab® solution, the mixer is emptied. An aliquot of about 10 g of splits is immediately immersed in 200 ml of methanol to quench the reaction and to be able to control the degree of cationic substitution achieved on exiting the mixer.

The rest of the splits are spread out as a thin layer on a metal plate placed for 3 hours in an oven at 60° C. After these 3 hours, the residual humidity of the splits is controlled by weight loss at 80° C. using a halogen thermobalance. The measured humidity is 5%.

The dry splits are finally milled with a hammer mill equipped with a 500 μm grate.

The degrees of substitution (DS_{cat}) are measured by NMR. The following are obtained:
on exiting the mixer, DS_{cat}=0.10, i.e. a selectivity of 40%
on exiting the dryer, DS_{cat}=0.22, i.e. a selectivity of 88%

### Example 2

The impregnation conditions of Example 1 are repeated except for one difference: the splits are at 25° C. when introduced into the mixer.

After impregnation with the sodium hydroxide solution and then with the solution of Quab 188, an aliquot of about 10 g of splits is immediately immersed in 200 ml of methanol to quench the reaction and to be able to control the degree of cationic substitution achieved on exiting the mixer.

The degree of substitution (DS_{cat}) measured by NMR is:
on exiting the mixer, DS_{cat}=0.08, i.e. a selectivity of 32%

The rest of the splits are divided into two substantially equal parts.

The first part is dried in a fluidized bed for 10 minutes with air at 80° C. The residual humidity measured is 5%. The dry splits are milled with a hammer mill equipped with a 500 μm grate.

The second part is dried and milled simultaneously. To do this, a stream of air at 270° C. passes through the hammer mill throughout the milling. The residence time of the solid in the mill is from 30 to 45 seconds. The residual humidity measured after this flash drying is 7.6%.

The degrees of substitution (DS_{cat}) measured by NMR are:
after drying in a fluidized bed, DS_{cat}=0.19, i.e. a selectivity of 76%
after flash drying, DS_{cat}=0.12, i.e. a selectivity of 48%

This example shows that satisfactory results may also be obtained when the splits are not preheated.

Moreover, this example demonstrates that a reactive drying step may be performed in a fluidized bed, which is readily industrializable technology.

Finally, this example illustrates the difference in the gain in selectivity obtained between drying under controlled conditions and flash drying.

### Example 3

The conditions of Example 2 are repeated except for one difference:
the drying is performed in a fluidized bed for 30 minutes with air at 50° C.

The measured residual humidity is 5%. The degrees of substitution (DS_{cat}) measured by NMR are:
on exiting the mixer, DS_{cat}=0.07, i.e. a selectivity of 28%
on exiting the dryer, DS_{cat}=0.14, i.e. a selectivity of 56%

This example thus demonstrates that the selectivity is reduced when the drying temperature is insufficiently high, i.e. below 60° C.

### Example 4

The conditions of Example 2 are repeated except for one difference:
the mixing time with the sodium hydroxide is only 3 minutes before introduction of the Quab®

The measured residual humidity is 5%. The degrees of substitution (DS_{cat}) measured by NMR are:
on exiting the mixer, DS_{cat}=0.07, i.e. a selectivity of 28%
on exiting the dryer, DS_{cat}=0.14, i.e. a selectivity of 56%

This example thus demonstrates that the selectivity is reduced when the mixing time with the sodium hydroxide is too short, in the present case less than 5 minutes.

### Example 5

The amounts of reagents are identical to those of Example 1.

The initial temperature of the splits and of the reagent solutions is 22-23° C.; the temperature of the heat-exchange fluid in the mixer jacket is 30° C.

The impregnation times after adding the sodium hydroxide and then after adding the Quab 188 are both 30 minutes.

The drying is performed in a fluidized bed for 20 minutes with air at 80° C. The residual humidity at the end of drying is 3.8%.

The degrees of substitution (DS_{cat}) measured by NMR are:
on exiting the mixer, DS_{cat}=0.09, i.e. a selectivity of 36%
on exiting the dryer, DS_{cat}=0.22, i.e. a selectivity of 88%

This example demonstrates that very good results in terms of selectivity may be obtained after reactive drying if the impregnation times are adapted as a function of the working temperatures.

### Example 6

The amounts of reagents are identical to those of Example 1.

The initial temperature of the splits is 22-23° C. The reagent solutions (sodium hydroxide and Quab 188) are preheated to 60° C. before introduction into the mixer. The temperature of the heat-exchange fluid in the mixer jacket is 65° C.

The impregnation times after adding the sodium hydroxide and then after adding the Quab® 188 are both 30 minutes.

Flash drying is performed simultaneously with the milling step. To do this, a stream of air at 270° C. passes through the hammer mill throughout the milling. The residence time of the solid in the mill is from 30 to 45 seconds. The residual humidity measured after this flash drying is 6.8%.

The degrees of substitution (DS_{cat}) measured by NMR are:
on exiting the mixer, DS_{cat}=0.17, i.e. a selectivity of 68%
on exiting the flash dryer, DS_{cat}=0.19, i.e. a selectivity of 76%

This example demonstrates that good results in terms of selectivity may be obtained directly on exiting the mixer if the impregnation times and the working temperatures are increased. Flash drying then leads to a very satisfactory final selectivity.

### Example 7

The references of the reagents used are those indicated in Example 1.

200 g of splits, stored at 22° C., are placed in the laboratory mixer. The temperature of the heat-exchange fluid in the mixer jacket is 65° C.

An aqueous sodium hydroxide solution was prepared beforehand by dissolving 14.9 g of sodium hydroxide pellets in 80 g of water, i.e. 20% less than in the preceding examples. 0.40 g of borax decahydrate, a galactomannan crosslinking agent, was then dissolved in this solution. This solution, preheated to 60° C., is poured over 30 seconds onto the splits in motion.

Immediately after the sodium hydroxide solution, 6.7 g of an aqueous 30% hydrogen peroxide solution are poured onto the splits in motion. Hydrogen peroxide is a galactomannan depolymerizing agent. The temperature of this aqueous solution is 22° C.

After 30 minutes of mixing with these two solutions, 64.6 g of an aqueous solution containing 65% by weight of Quab® 188 are poured in over 30 seconds onto the splits in motion. As for the sodium hydroxide, the amount of Quab® is thus reduced by 20% relative to the preceding examples. This Quab® solution was also preheated to 60° C. before introduction into the mixer.

After 30 minutes of mixing with the Quab® solution, 36 g of aqueous 10% hydrochloric acid solution are poured in over 20 seconds onto the splits in motion. The aim of this last step of the synthesis is to partially neutralize the excess sodium hydroxide and to reinforce the crosslinking with borax after the cationization step.

After 20 minutes of mixing with the hydrochloric acid solution, the mixer is emptied. An aliquot of about 10 g of splits is immediately immersed in 200 ml of methanol to quench the reaction and to be able to control the degree of cationic substitution achieved on exiting the mixer.

The rest of the splits are dried and milled simultaneously. To do this, a stream of air at 270° C. passes through the hammer mill throughout the milling. The residence time of the solid in the mill is from 30 to 45 seconds. The residual humidity measured after this flash drying is 6.8%.

The degrees of substitution (DS_{cat}) measured by NMR are:
after drying in a fluidized bed, DS_{cat}=0.10, i.e. a selectivity of 50%
after flash drying, DS_{cat}=0.12, i.e. a selectivity of 55%

This example illustrates the case in which the depolymerization and crosslinking steps are performed.

### Example 8

Shampoo compositions containing cationic galactomannans according to the invention were prepared in order to evaluate the performance qualities of these cationic galactomannans in terms of deposition of silicone.

The cationic galactomannans prepared in Examples 1, 3 and 7 were incorporated into a shampoo composition, described in the table below. The amount of each of the compounds is expressed as a mass percentage of the total formulation taking into account the active part of the compound.

| | | | Mass % of |
|---|---|---|---|
| Compounds | Trade name | Supplier | active agent |
| Sodium laureth | Rhodapex ® | Rhodia | 14 |
| sulfate | ES-2K | | |
| Cocamidopropylbetaine | Mirataine ® | Rhodia | 2 |
| | BET C- | | |
| Galactomannan | — | — | 0.3 |
| according to the | | | |
| Dimethicone | Mirasil ® | Bluestar | 1 |
| emulsion | DM 500000 | Silicones | |
| Sodium chloride | — | — | 1.8 |
| Citric acid | — | — | Sufficient |
| (pH 6.0-6.5) | | | quantity |
| Preserving | — | — | Sufficient |
| agent | | | quantity |
| Water | — | — | Remainder |
| | | | to 100 |

For comparative purposes, identical shampoo compositions were prepared, replacing the cationic galactomannan with cationic guars different from those of the invention, namely Jaguar C17®, Jaguar C14S® or Jaguar C500®.

The silicone deposition efficacy of the shampoos thus prepared was measured using a calibrated hair braids of reference Virgin Medium Brown Caucasian Hair supplied by the company IHIP (International Hair Importers & Products Inc.). The hair braid has a mass of 4.5 g and a length of 20 cm, one of its ends comprising a fixing clip.

The measuring method comprises four steps: treatment of the hair braids with a 10% sodium laureth sulfate (SLES) solution, treatment of the hair braids with the shampoo to be evaluated comprising dimethicone, extraction of the dimethicone with tetrahydrofuran (THF) and assay of the extracted dimethicone by permeable gel chromatography (PGC). The protocol used for each of these steps is described in detail hereinbelow.

### 1. Pretreatment of the Hair Braids

The hair braids were pretreated with a 10% SLES solution and were then rinsed with water before the following step of treatment with the shampoo containing dimethicone.

The pretreatment protocol was as follows: each braid was subjected to a controlled stream of water (150 ml/min at 38° C.) for 1 minute, and 3 ml of the 10% SLES solution were then applied along the braid. Finally, the braid was rinsed with water for 1 minute.

### 2. Treatment of the Hair

About 450 mg of shampoo were weighed out and the exact mass was noted precisely. The hair braid was wound around a finger and the shampoo was applied thereon. Next, the shampoo on the braid was massaged for 45 seconds, taking care to ensure that the product was applied equally along the entire braid. Finally, the braid was rinsed with water for 30 seconds. The excess water was removed from the braid by passing the index and middle fingers through the braid, and the braid was left to dry in the ambient air and to equilibrate overnight in an air-conditioned room (21° C., 50% relative humidity).

### 3. Extraction of the Dimethicone

For each of the braids, 250 ml polyethylene bottles were tared. Each braid was placed in a bottle, keeping the fixing clip outside the bottle. Each braid was then cut just below the clip and the amount of hair introduced into each bottle was noted. Next, about 100 ml of THF were placed in each bottle before closing them. All the bottles were placed on a plate shaker and shaken for 24 hours at 200 rpm. In a fume cupboard, the THF extraction solution was transferred into a 150 ml evaporation capsule and left to evaporate (maximum ventilation rate) for 24 hours in the fume cupboard. After evaporation, the evaporation capsule contained only the extracted dimethicone, deposited on the walls.

### 4. Assay of the Extracted Dimethicone

The evaporation capsule was tared with a watch glass covering it. Next, in the fume cupboard, about 4 ml of THF were placed in the evaporation capsule. Using a spatula, the dimethicone deposited on the walls of the evaporation capsule was redissolved. After total dissolution, the evaporation capsule covered with the watch glass was weighed and the amount of THF introduced noted. Using a syringe, the dimethicone solution was transferred into a 2 ml tube, which was then closed. The dimethicone concentration was assayed in the tube by PGC.

The amount Q of dimethicone deposited on the hair, expressed in ppm (μg of dimethicone per g of hair), was determined by means of the following relationship:

$$Q = \frac{{C}_{dimethicone} \times {m}_{THF}}{{m}_{hair}}$$

in which C_{dimethicone} is the concentration of dimethicone in the PGC tube, expressed in ppm (μg of dimethicone per g of THF),
m_{THF} is the mass of THF, expressed in g, used to dissolve the dimethicone in the evaporation capsule, and
mₕₐᵢᵣ is the mass of hair, expressed in g, introduced into the polyethylene bottle.

Moreover, the deposition yield R was determined via the following relationship:

$$R ( \% ) = \frac{{C}_{dimethicone} \times {m}_{THF}}{{m}_{shampoo} \times φ}$$

where Mₛₕₐₘₚₒₒ is the mass of shampoo, expressed in μg, used to treat the hair braid, and φ is the concentration of dimethicone in the shampoo.

A minimum of two braids were used for each of the compositions in order to calculate the mean amount of dimethicone deposited on the hair and the mean deposition yield.

The results obtained in the silicone deposition test for each of the examples tested are indicated in the tables below.

The performance of Example 1 was compared with that of Jaguar Cl₇a

| Guar used | DS | Yield (%) |
|---|---|---|
| Jaguar C17 ® | 0.20 | 57 |
| Example 1 | 0.22 | 59 |

The performance of Example 3 was compared with that of Jaguar C14S®:

| Guar used | DS | Yield (%) |
|---|---|---|
| Jaguar C14S ® | 0.15 | 48 |
| Example 3 | 0.14 | 51 |

The performance of Example 7 was compared with that of Jaguar C500®:

| Guar used | DS | Yield (%) |
|---|---|---|
| Jaguar C500 ® | 0.10 | 26 |
| Example 7 | 0.12 | 30 |

These results demonstrate that the silicone deposition yields obtained with the shampoos containing cationic galactomannans according to the invention are comparable to those obtained with conventional cationic guars, or even higher.

The process of the invention thus has the advantage of reducing the process times and the costs, while at the same time making it possible to prepare cationic galactomannans whose properties in terms of silicone deposition are comparable to those of known cationic guars.

1. A process for preparing cationic galactomannan, comprising the following steps:
a) a step of impregnating galactomannan with an alkaline agent;
b) a step of impregnating the mixture formed after said step a) with a cationic agent; and
c) a step of drying the mixture formed after said step b).

2. The process as claimed in claim 1, wherein the galactomannan is chosen from guars.

3. The process as claimed in claim 1, wherein the galactomannan is in the form of splits.

4. The process as claimed in claim 1, is performed continuously.

5. The process as claimed in claim 1, wherein said step a) is performed for an impregnation time of at least 15 minutes, at a temperature of between 55° C. and 65° C.

6. The process as claimed in claim 1, wherein said step b) is performed for an impregnation time of at least 15 minutes, at a temperature of between 55° C. and 65° C.

7. The process as claimed in claim 1, wherein said step a) comprises a step of addition of an aqueous solution of the alkaline agent to the galactomannans maintained at a temperature below 90° C.

8. The process as claimed in claim 1, wherein an aqueous solution of the alkaline agent is added at a temperature below 90° C.

9. The process as claimed in claim 1, wherein the alkaline agent is used in excess relative to the cationic agent.

10. The process as claimed in claim 9, wherein the ratio between the number of moles of the alkaline agent and the number of moles of the cationic agent is from 1.5 to 2.5.

11. The process as claimed in claim 1, wherein, during step c), the drying air temperature is greater than or equal to 60° C.

12. The process as claimed in claim 1, in which wherein during said step c), the drying time is greater than or equal to 5 minutes.

13. The process as claimed in claim 1, wherein the cationic galactomannan obtained after the drying step has a moisture content of less than 5%.

14. The process as claimed in claim 1, comprising a step of depolymerization of the galactomannans and/or a step of crosslinking of the galactomannans, wherein the depolymerization step being performed after said step a) and before said step b) and the crosslinking step being performed after said step b).

15. The process as claimed in claim 1, wherein the cationic galactomannan obtained after said process has a degree of cationic substitution DS_{cat} of from 0.1 to 0.3.

16. The process as claimed in claim 1, has a selectivity of greater than 80%.

17. The process as claimed in claim 1, wherein the alkaline agent is sodium hydroxide.

18. The process as claimed in claim 1, wherein the cationic agent is 3-chloro-2-hydroxypropyltrimethylammonium chloride.

19. The process as claimed in claim 1, does not comprise a washing step.
